(19) United States
(12) Patent Application Publication
(10) Pub. No.: US 2016/0063203 A1
(43) Pub. Date: Mar. 3, 2016

(54) TERMINAL DEVICE, MEDICAL DEVICE, AND MEDICAL INFORMATION SYSTEM

(71) Applicant: SAMSUNG ELECTRONICS CO., LTD., Suwon-si (KR)

(72) Inventor: Seong Eun SEO, Suwon-si (KR)

(73) Assignee: SAMSUNG ELECTRONICS CO., LTD., Suwon-si (KR)

(21) Appl. No.: 14/827,499

(22) Filed: Aug. 17, 2015

(30) Foreign Application Priority Data
Sep. 3, 2014 (KR) 10-2014-0116759

(51) Int. Cl. G06F 19/00

(52) U.S. Cl. CPC G06F 19/3412; G06F 19/322

(57) ABSTRACT

A terminal device is provided. The terminal device includes: an input unit through which pieces of patient information are input from a user; and a communication unit that transmits inspection request signals including the pieces of patient information to a plurality of medical devices, wherein, when the pieces of patient information are registered in one of the plurality of medical devices, the communication unit transmits deletion request signals of the patient information to the other medical devices.

### CROSS-REFERENCE TO RELATED APPLICATION

This application claims priority from Korean Patent Application No. 10-2014-0116759, filed on Sep. 3, 2014 in the Korean Intellectual Property Office, the disclosure of which is incorporated herein by reference.

### BACKGROUND

1. Field

Exemplary embodiments of relate to a terminal device, a medical device, and a medical information system.

2. Related Art

In general, medical devices are devices that acquire information regarding a patient to provide an image of the patient, or capture an image of the patient, or diagnose the patient to acquire desired information regarding the patient. Medical devices may include an X-ray device, an ultrasonic diagnosis device, a computer tomography (CT) device, and a magnetic resonance imaging (MRI) device.

Such medical devices include a worklist including pieces of patient information registered by a user. The user may receive the pieces of patient information through a telephone call or memo and may input the received pieces of patient information to each medical device manually.

In order to simplify a procedure for registering the pieces of patient information, a separate device capable of transmitting the pieces of patient information to the medical device from a remote location has been implemented. However, as the user requests the patient information to be simultaneously registered in several medical devices, the pieces of patient information are frequently redundantly registered in a plurality of medical devices.

### SUMMARY

According to an aspect of an exemplary embodiment, a terminal device that transmits pieces of patient information to a plurality of medical devices by inputting the pieces of patient information and prevents the pieces of patient information from being redundantly registered in the plurality of medical devices is provided.

According to an aspect of another exemplary embodiment, a medical device that displays pieces of patient information received via a network and controls displaying of the pieces of patient information based on whether the patient information are registered in the remaining medical devices is provided.

According to an aspect of another exemplary embodiment, a medical information system that transmits pieces of patient information to a plurality of medical devices by inputting the pieces of patient information using a terminal device and prevents the pieces of patient information from being redundantly registered in the plurality of medical devices is provided.

Additional aspects of the exemplary embodiments will be set forth in part in the description which follows and, in part, will be obvious from the description, or may be learned by practice of the exemplary embodiments.

According to an aspect of an exemplary embodiment, a terminal device is provided. The terminal device includes: an input configured to receive pieces of patient information from a user; and a transceiver configured to transmit an inspection request including the pieces of patient information to a plurality of medical devices, and a controller configured to, in response to the pieces of patient information being registered in one of the plurality of medical devices, control the transceiver to transmit a deletion request of the patient information to remaining devices of the plurality of medical devices.

The terminal device may further include a display that displays the patient information.

The controller may delete the pieces of patient information received from the user when the pieces of patient information are registered in one of the plurality of medical devices.

In response to the transceiver receiving a deletion request signal, the transceiver may transmit the deletion request to the remaining devices of the plurality of medical devices.

Each of the pieces of patient information may include a user's ID, a part to be imaged, and a user's location.

According to an aspect of another exemplary embodiment, a medical device is provided. The medical device includes: a transceiver configured to receive an inspection request including pieces of patient information and a deletion request of the pieces of patient information; a display configured to display the patient information based on the inspection request; and a controller configured to delete the pieces of patient information in response to the transceiver receiving the deletion request.

The display may display a worklist in which the pieces of patient information registered in the medical device are listed.

The medical device may further include an input configured to receive a user selection about whether to register the received patient information.

The display may display a worklist in which the pieces of patient information registered in the medical device are listed, and the controller may add the received pieces of patient information to the worklist when the user selects to register the received patent information using the input.

When the user selects not to register the received patient information using the input, the controller may delete the pieces of patient information based on the inspection request.

The medical device may further include a storing in which the registered pieces of patient information are stored.

The transceiver may receive the inspection request and the deletion request from at least one of a mobile terminal device and a server.

Each of the pieces of patient information may include a user's ID, a part to be imaged, and a user's location.

The display may further display a pop-up message informing that the inspection request are received.

The medical device may further include an input through which the user selects the pop-up message, wherein, when the user selects the pop-up message through the input, the display may display the patient information based on the inspection request.

According to an aspect of another exemplary embodiment, a medical information system is provided. The medical information system includes: a terminal device that transmits inspection request including pieces of patient information to a medical device; and a plurality of medical devices that determine whether to register the pieces of patient information, wherein, when the pieces of patient information are registered in one of the plurality of medical devices, the terminal device may transmit a deletion request to request deletion of the patient information to remaining medical devices of the plurality of medical devices.

In the plurality of medical devices, a user selects whether to register the pieces of patient information in the one of the plurality of medical devices, the terminal device may transmit the deletion request to the other medical devices.

When the pieces of patient information are registered in the one of the plurality of medical devices, the one of the plurality of medical devices may transmit the deletion request to the terminal device.

One of the plurality of medical devices may display a worklist in which the registered pieces of patient information are listed.

When the pieces of patient information are registered in the one of the plurality of medical devices, the one of the plurality of medical devices may add the pieces of patient information to the worklist.

According to an aspect of another exemplary embodiment, a terminal device is provided. The terminal device includes a controller configured to receive patient information; a transceiver configured to transmit an inspection request including the patient information to a plurality of medical devices, wherein, in response to the patient information being registered in one of the plurality of medical devices, the controller is configured to delete the received patient information.

In response to the patient information being registered in one of the plurality of medical devices, the controller may be further configured to control the transceiver to transmit a deletion request of the patient information to remaining devices of the plurality of medical devices.

In response to the transceiver receiving a deletion request from one of the plurality of medical devices, the controller may be further configured to control the transceiver to transmit the deletion request to remaining devices of the plurality of medical devices.

### BRIEF DESCRIPTION OF THE DRAWINGS

These and/or other aspects of the exemplary embodiment will become apparent and more readily appreciated from the following description of the exemplary embodiments, taken in conjunction with the accompanying drawings of which:

FIGS. 1 and 2 are views schematically illustrating a medical information system in accordance with an exemplary embodiment;

FIGS. 3, 4, and 5 are views illustrating a medical device in accordance with an exemplary embodiment;

FIG. 6 is a block diagram of a terminal device in accordance with an exemplary embodiment;

FIGS. 7A and 7B are views of examples of pieces of patient information displayed by a display unit;

FIG. 8 is a block diagram of a medical device in accordance with another exemplary embodiment;

FIGS. 9 through 12 are views of the pieces of patient information displayed by the display unit and a worklist;

FIGS. 13A through 13C are views for describing a signal transmitting operation of a medical information system in accordance with another exemplary embodiment; and

FIGS. 14 and 15 are flowcharts illustrating a method of controlling a medical information system, in accordance with an exemplary embodiment.

### DETAILED DESCRIPTION OF EXEMPLARY EMBODIMENTS

Reference will now be made in detail to the exemplary embodiments, which are illustrated in the accompanying drawings, wherein like reference numerals refer to like elements throughout. It should be noted that, in the specification, when reference numerals are added to elements of each of the drawings, same reference numerals have to be added to same elements as possible, even though the elements are indicated in different drawings. In the description of the exemplary embodiments, if it is determined that a detailed description of commonly-used technologies related to the inventive concept may unnecessarily obscure the subject matter, the detailed description will be omitted. While such terms as “first,” “second,” etc., may be used to describe various components, such components must not be limited to the above terms. The above terms are used only to distinguish one component from another.

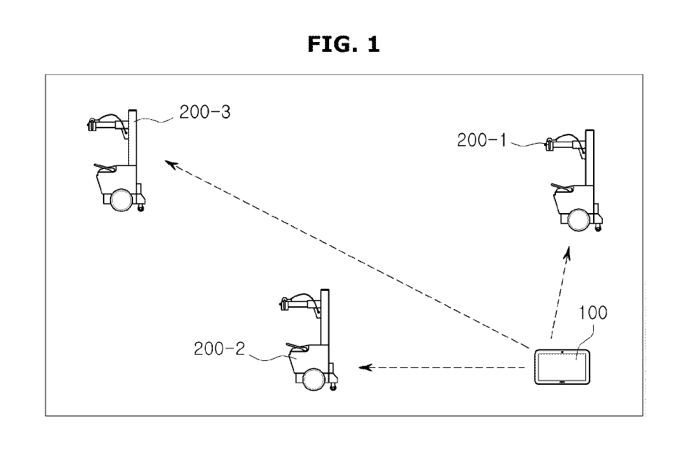

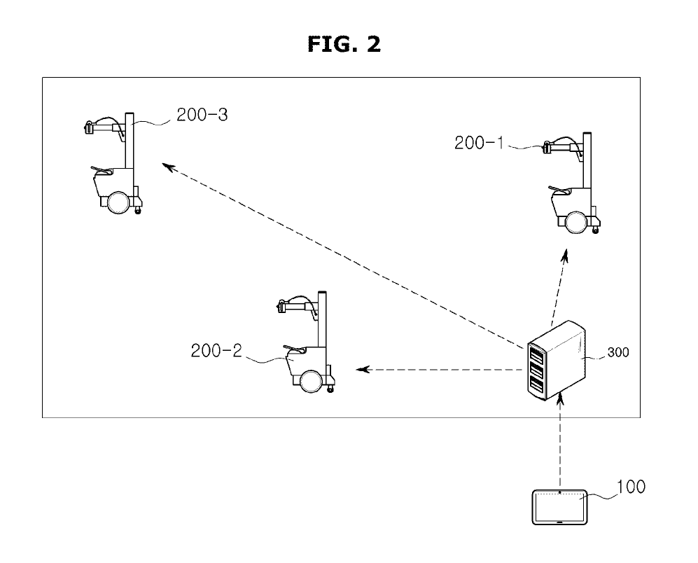

Hereinafter, a medical information system will be described with reference to FIGS. 1 and 2. FIGS. 1 and 2 are views schematically illustrating a medical information system in accordance with an exemplary embodiment.

Referring to FIG. 1, the medical information system includes a terminal device 100 that transmits inspection request signals (i.e., an inspection request) including pieces of patient information to a medical device and a plurality of medical devices 200 including 200-1, 200-2, and 200-3 that determine whether the pieces of patient information are registered. Referring to FIG. 2, the medical information system may further include a server 300 that mediates a signal transmitting procedure between the terminal device 100 and the plurality of medical devices 200. For example, the server 300 may be an intermediary for the information transmitted between the terminal device 100 and the plurality of medical devices 200.

The terminal device 100 is a device for transmitting the inspection request signals including the patient information to the plurality of medical devices 200 so as to register the patient information input by a user in the medical devices 200. The terminal device 100 may be implemented with the medical devices 200 via a network or a computer or portable terminal equipment that may be connected to the server 300 that will be described with reference to FIG. 2 later. Here, examples of the computer include a notebook computer, a desktop computer, a laptop computer, a tablet personal computer (PC), and a slate PC with a WEB browser built therein, and examples of the portable terminal equipment that is a wireless communication device with guaranteed portability and mobility, include all kinds of handheld-based wireless communication devices, such as a personal communication system (PCS) terminal, a global system for mobile communications (GSM) terminal, a personal digital cellular (PDC) terminal, a personal handyphone system (PHS) terminal, a personal digital assistant (PDA) terminal, an international mobile telecommunication (IMT)-2000 terminal, a code division multiple access (CDMA)-2000, a W-code division multiple access (W-CDMA) terminal, a wireless broadband Internet (WiBro) terminal, a tablet PC, and a smart phone.

The user transmits the recognized patient information to the medical devices 200 using the terminal device 100, adds the patient information to a worklist using the medical devices 200, or performs diagnosis of an object by referring to the registered pieces of patient information, may be a medical team including a doctor, a radiologist, and a nurse. However, the exemplary embodiments are not limited thereto. Anyone who uses the terminal device 100 or the medical devices 200 may be the user.

The pieces of patient information may include all kinds of information relating to a patient to be inspected using the medical devices 200 such as the patient's name, the patient's resident registration number, the patient's part to be imaged, the patient's ID, the patient's current location, the user's management number, and other various information relating to the patient.

The inspection request signals are used to request inspection from the medical devices 200 and include the patient information. As illustrated in FIG. 1, the terminal device 100 may transmit the inspection request signals to a plurality of medical devices, for example, first through third medical devices 200-1, 200-2, and 200-3.

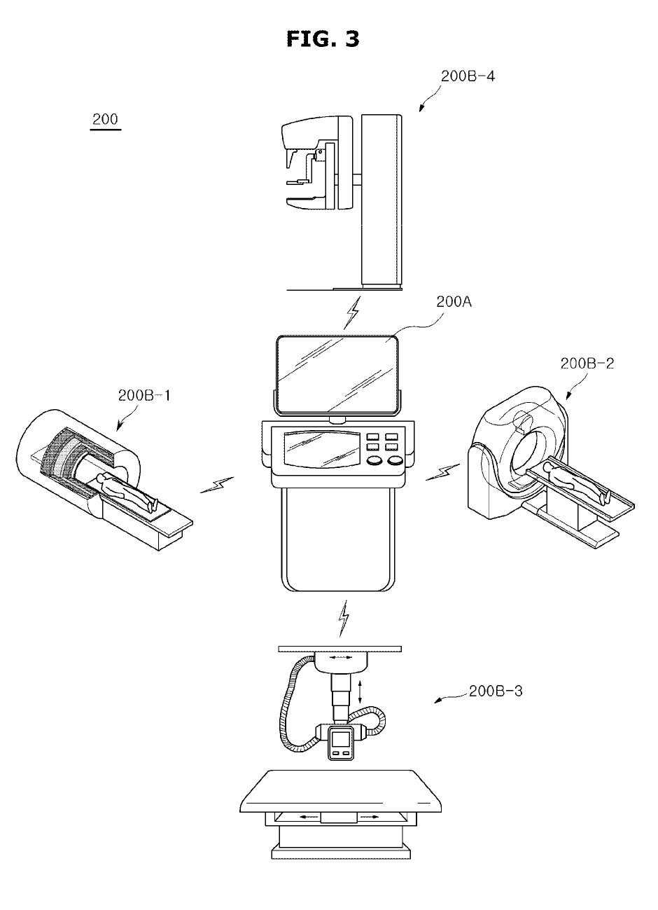

The medical devices 200 may display a worklist in which pieces of information regarding the patient to be inspected are listed to the user who uses the medical devices 200. The medical devices 200 may include image capturing units 200B-1, 200B-2, 200B-3, and 200B-4 and a host device 200A. FIGS. 3, 4, and 5 are views for describing examples of the medical devices 200.

Referring to FIG. 3, the medical devices 200 may include image capturing units 200B-1, 200B-2, 200B-3, and 200B-4 that capture images inside or outside an object ob and the host device 200A that matches the images received from the image capturing units 200B-1, 200B-2, 200B-3, and 200B-4.

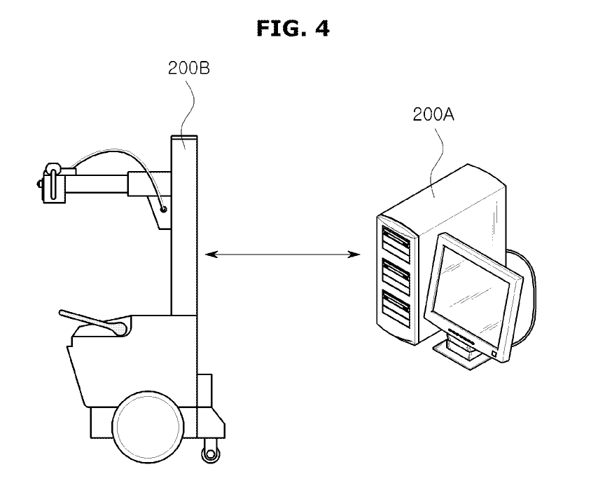

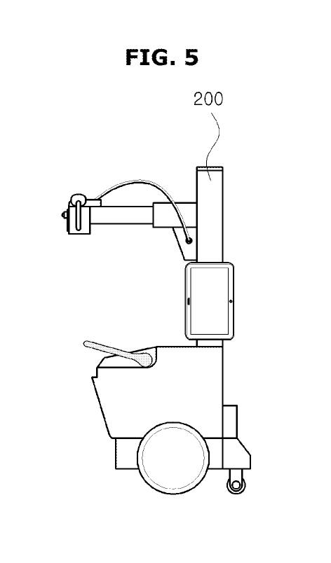

As illustrated in FIG. 4, the image capturing units 200B-1, 200B-2, 200B-3, and 200B-4 may be installed to be spaced a predetermined distance from the host device 200A of the medical devices 200. When they are installed to be spaced the predetermined distance from the host device 200A of the medical devices 200, the image capturing units 200B-1, 200B-2, 200B-3, and 200B-4 and the host device 200A may be connected to one another using various wired/wireless communication protocols. Further, as illustrated in FIG. 5, the image capturing units 200B and the host device 200A may be combined with one device and may also be connected to each other via a circuit.

When the image capturing units 200B-1, 200B-2, 200B-3, and 200B-4 may be installed to be spaced a predetermined distance from the host device 200A of the medical devices 200, as illustrated in FIG. 4, for example, the image capturing units 200B-1, 200B-2, 200B-3, and 200B-4 may perform data communication with the host device 200A based on digital imaging and communications in medicine (DICOM) standards. However, the exemplary embodiments are not limited thereto. The image capturing units 200B-1, 200B-2, 200B-3, and 200B-4 and the host device 200A may be connected to one another using a mobile radio communication protocol, such as global system for mobile communication (GSM), code division multiple access (CDMA), wideband code division multiple access (WCDMA), time division multiple access (TDMA), or long term evolution (LTE), or a local area communication protocol, such as wireless local access network (WLAN), bluetooth, Zigbee, and near field communication (NFC).

In this case, the image capturing units 200B-1, 200B-2, 200B-3, and 200B-4 that acquire images inside the object ob, may acquire internal images using radiographic rays, a magnetic resonance phenomenon, or ultrasonic waves. For example, the image capturing units 200B-1, 200B-2, 200B-3, and 200B-4 may acquire images inside the object ob using radiographic rays, like in a computed tomography (CT) device, a positron emission tomography (PET) device, a single photon emission computed tomography (SPECT) device or a mammography device. In addition, the image capturing units 10 may acquire images inside the object ob using magnetic resonance, like in a magnetic resonance imaging (MRI) device, or may acquire images inside the object ob using ultrasonic waves.

As described above, the image capturing units 200B-1, 200B-2, 200B-3, and 200B-4 may acquire the images of the object ob using various methods. However, image acquisition methods have advantages and disadvantages, respectively. For example, a CT has a relatively short inspection time and a slightly low cost, but MRI has a relatively long inspection time and a high cost but may acquire images having high resolution.

Preferences of image acquisition methods differ according to an internal structure or features of the object ob. For example, when the object ob is the human body, a preferred image acquisition method for diagnosing a disease of each organ of the human body may differ according to a structure of an organ or features of each organ. Thus, images may be acquired using the preferred image acquisition method according to each organ, and diagnosis may be further facilitated by matching the images acquired by the preferred image acquisition method according to each organ. Since the images are acquired using the preferred image acquisition method according to each organ, time and cost required to acquire the images for diagnosis may be reduced.

The medical devices 200 according to the present exemplary embodiment may be installed in a space, as illustrated in FIGS. 1 and 2, for example, movably in a hospital or may also be fixedly installed in a predetermined zone of the hospital. The plurality of medical devices 200-1, 200-2, and 200-3 may be installed in the hospital and may capture images of the object ob using the same imaging method or different imaging methods.

Each of the medical devices 200-1, 200-2, and 200-3 may receive the pieces of patient information from the user, may add or register the received patient information to or in the worklist, and may add or register the pieces of patient information received from the terminal device 100 to or in the worklist, as illustrated in FIG. 1. In this case, the user may select whether to register the patient information received from the terminal device 100 in the worklist.

Referring to FIG. 2, a medical information system according to another exemplary embodiment may further include a server 300. In the exemplary embodiment including the server 300, when the terminal device 100 transmits inspection request signals including pieces of patient information to the server 300, the inspection request signals received by the server 300 may be transmitted to the plurality of medical devices 200-1, 200-2, and 200-3. The server 300 serves as a intermediary for managing connection between the terminal device 100 and the plurality of medical devices 200-1, 200-2, and 200-3.

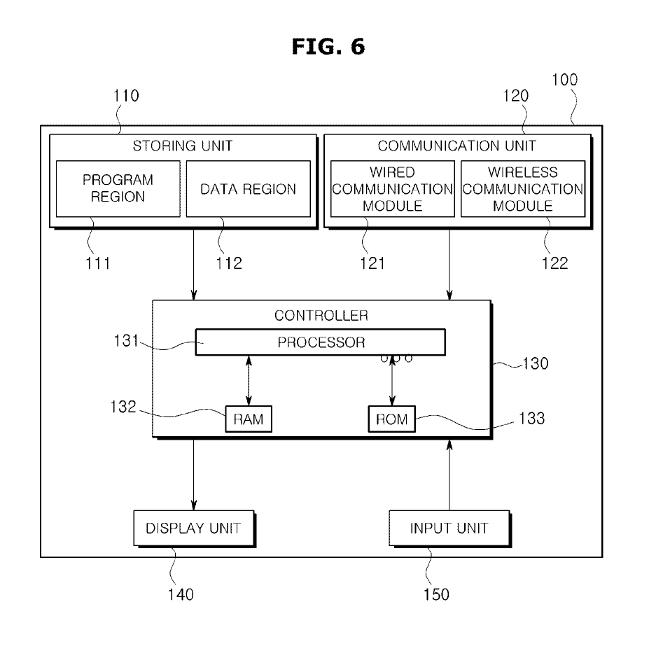

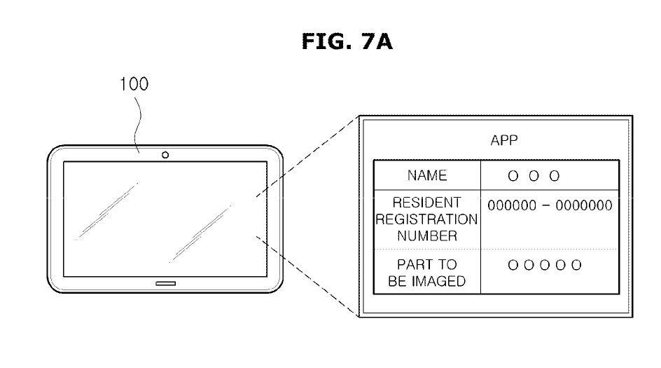

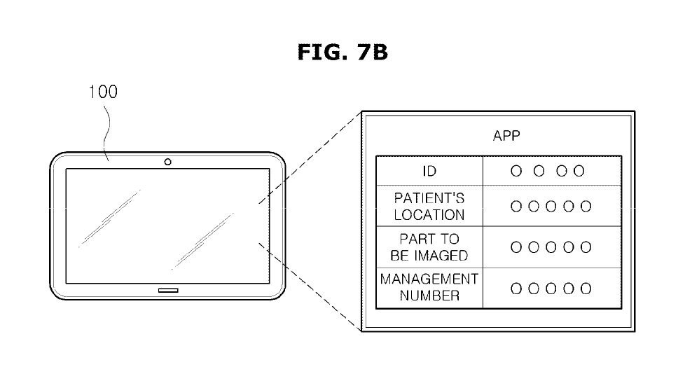

Hereinafter, an operation of each component of the medical information system will be described with reference to FIGS. 6 and 7.

FIG. 6 is a block diagram of a terminal device 100 in accordance with an exemplary embodiment.

The terminal device 100 according to an exemplary embodiment includes a storing unit 110 (e.g., a storage, a memory, etc.) in which program and data required to control the terminal device 100 are stored, a communication unit 120 (e.g., a transceiver, communicator, etc.) connected to a wired or wireless network, a controller 130 that controls an operation of the terminal device 100, a display unit 140 (e.g., a display, etc.) that audiovisually outputs data to the user, and an input unit 150 (e.g., an input, etc.) through which the data is input by the user.

A program required for an overall function operation of the terminal device 100 and pieces of patient information input to the terminal device 100 may be stored in the storing unit 110. The storing unit 110 may include a program region 111 and a data region 112.

An operating system (OS) that boots the program for controlling the overall operation of the terminal device 100 may be stored in the program region 111. The program region 111 may include a program or application relating to an operation of the controller 130.

The pieces of patient information input through the input unit 150 from the user may be stored in the data region 112 that is a region in which data generated when the terminal device 100 is used is stored. The patient information may include the patient's name, the patient's resident registration number, and the patient's part to be imaged, as illustrated in FIG. 7A, or the patient's ID, the patient's current location, the user's management number, as illustrated in FIG. 7B, and other various information relating to the patient.

In this case, the storing unit 110 may be implemented with at least one of a nonvolatile memory device, such as a cache, a read only memory (ROM), programmable ROM (PROM), an erasable programmable (EPROM), an electrically erasable programmable ROM (EEPROM), and a flash memory, a volatile memory device, such as a random access memory (RAM), or a storage medium, such as a hard disk drive (HDD) or CD-ROM. However, the exemplary embodiments are not limited thereto.

The communication unit 120 connects the terminal device 100 and the plurality of medical devices 200 or the server 300 using the wired/wireless network. In detail, when the communication unit 120 transmits the inspection request signals including the pieces of patient information to the plurality of medical devices 200 and receives deletion request signals (i.e., a deletion request) of the pieces of patient information from the medical devices 200 in which the patient information are registered, the communication unit 120 transmits the deletion request signals so as to prevent the patient information from being redundantly registered in the other medical device 200.

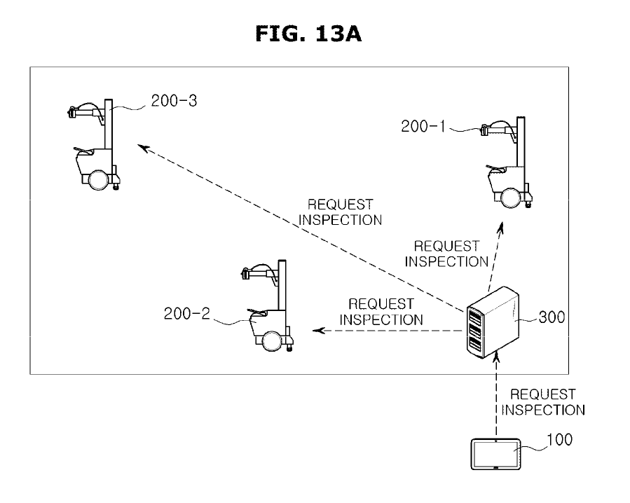

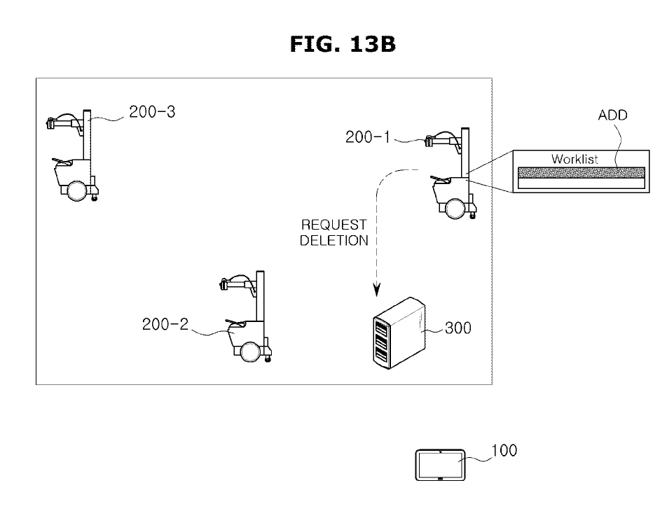

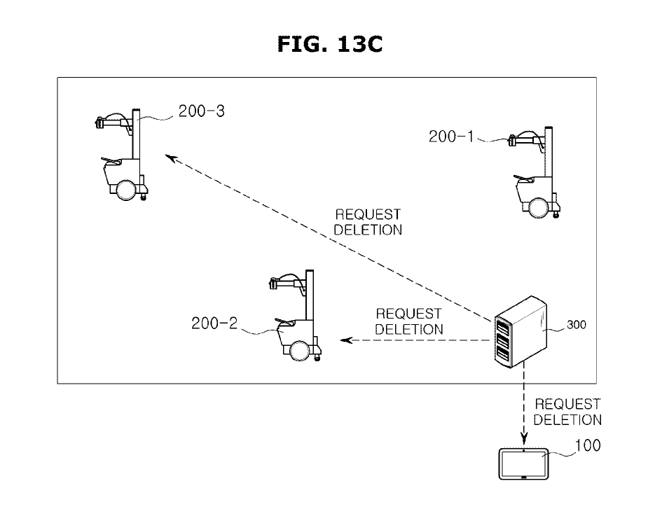

As illustrated in FIG. 2, when the server 300 serves as a intermediary for managing connections between the terminal device 100 and the plurality of medical devices 200-1, 200-2, and 200-3, if the communication unit 120 transmits the inspection request signals including the pieces of patient information to the plurality of servers 300 and receives the deletion request signals of the patient information from the medical devices 200 in which the pieces of patient information are registered via the server 300, the communication unit 120 transmits the deletion request signals to the servers 300 so as to prevent the pieces of patient information from being redundantly registered in the remaining medical device 200. A procedure for transmitting the inspection request signals and the deletion request signals will be described later with reference to FIGS. 13 through 15.

The communication unit 120 may include at least one of a wired communication module 121 through which the communication unit 120 is connected to a wired network, such as a local area network (LAN), a wide area network (WAN) or a value added network (VAN), and a wireless communication module 122 through which the communication unit 120 is connected to all kinds of wireless networks, such as a mobile radio communication network or a satellite communication network.

The controller 130 configured to control the overall operation of the terminal device 100 may perform several operations according to instructions to execute the stored program. The controller 130 may include a processor 131, a ROM 133 in which a control program for controlling the terminal device 100 is stored, and a RAM 132 in which signals or data input from an outside of the terminal device 100 are stored or which is used as a storage region corresponding to various tasks performed by the terminal device 100. The processor 131 may be implemented in the form of a system on chip (SoC) including a core and a graphic processing unit (GPU). The processor 131 may include a single core, a dual core, a triple core, a quad core, and a core of a multiple thereof.

The controller 130 may include a graphic processing board including the processor 131, the RAM 132 or the ROM 133 disposed on a separate circuit board electrically connected to the controller 130. The processor 131, the ROM 133, and the RAM 132 may be connected to one another via an internal bus.

The controller 130 may be used as the term that refers to as a component including the processor 131, the ROM 133, and the RAM 132. The controller 130 may also be used as the term that refers to as a component including the processor 131, the ROM 133, the RAM 132, and a graphic processing board (not shown).

In FIG. 6, the controller 130 includes the ROM 133 in which the control program for controlling the terminal device 100 is stored, and the RAM 132 in which signals or data input from the outside of the terminal device 100 are stored and which is used as a storage region corresponding to various tasks performed by the terminal device 100. However, the storing unit 110 may include a RAM and a ROM. The storing unit 110 may be disposed in the terminal device 100 or may be implemented to be inserted into the terminal device 100 as a portable device.

The controller 130 according to an exemplary embodiment may store or delete the patient information input from the user in the data region 112 according to the instructions input from the user and may delete the stored patient information according to deletion request signals received from the medical devices 200 in which the patient information are registered, or the server 300.

The display unit 140 displays the patient information input from the user audiovisually.

The display unit 140 may be implemented using a plasma display panel (PDP), a light emitting diode (LED) or a liquid crystal display (LCD) device. In addition, the display unit 140 may use a three-dimensional (3D) display that may represent 3D images. The display unit 140 may also include a touch screen device. When the display unit 140 includes the touch screen device, the display unit 140 may perform a function of the input unit 150. The touch screen device may be implemented using a decompression touch screen panel or a capacitive touch screen panel. Further, the touch screen device may also be implemented using a touch screen panel using ultrasonic waves or infrared rays. In addition, the display unit 140 may include a speaker that displays the patient information visually and outputs the patient information acoustically.

FIGS. 7A and 7B are views of examples of pieces of patient information displayed by the display unit 140.

Referring to FIGS. 7A and 7B, the display unit 140 displays a program or an application APP stored in the program region 111. The patient information input from the user may include the patient's name, the patient's resident registration number, and the patient's part to be imaged, as illustrated in FIG. 7A, or the patient's ID, the patient's current location, the user's management number, as illustrated in FIG. 7B. However, the pieces of patient information are not limited thereto and may further include various information relating to the patient.

Although not shown, the display unit 140 may display a separate “transmission” button and may transmit inspection request signals including the patient information to the plurality of medical devices 200 according to the user's selection.

The input unit 150 may allow the user to input various control instructions to the terminal device 100 and may include a plurality of screens through which control instructions may be input while the user sees the display unit 140 that may display pieces of patient information. The user may input characters, numbers or symbols for inputting the patient information using the input unit 150, may select whether to transmit the patient information, or may input other setting information including information for changing settings of the terminal device 100.

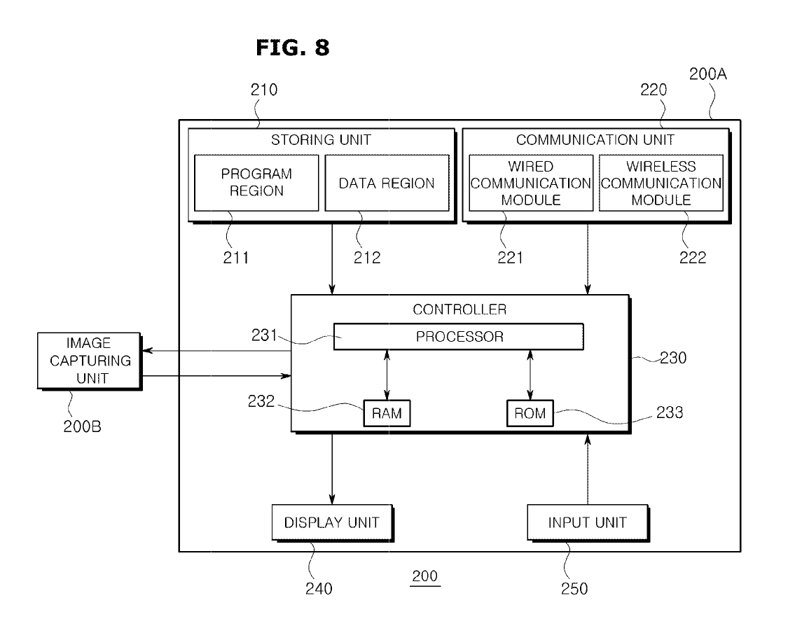

FIG. 8 is a block diagram of a medical device in accordance with another exemplary embodiment.

A medical device 200 according to an exemplary embodiment includes a host device 200A and an image capturing unit 200B. The host device 200A includes a storing unit 210 in which program and data required to control the medical device 200 are stored, a communication unit 220 connected to a wired/wireless network, a controller 230 that controls an operation of the medical device 200, a display unit 240 that outputs the data to the user audiovisually, and an input unit 250 through which the data is input from the user.

The image capturing unit 200B captures images inside or outside an object ob, matches the images received from the image capturing unit 200B, and generates a worklist based on the patient information input from the user or the patient information received from the terminal device 100. The worklist is a list in which one or more pieces of patient information are listed. The worklist may refer to reservation information regarding a patient whose imaging is performed by the medical device 200 and who is to be inspected.

As illustrated in FIG. 8, the image capturing unit 200B may be installed to be spaced a predetermined distance from the host device 200A of the medical device 200. When the image capturing unit 200B is installed to be spaced a predetermined distance from the host device 200A of the medical device 200, the image capturing unit 200B and the host device 200A may be connected to various wired/wireless communication protocols using the communication unit 220. As illustrated in FIG. 8, the image capturing unit 200B and the host device 200A may be combined with one device and may also be connected to each other via a circuit.

A program required for the overall function operation of the medical device 200 and patient information input to the medical device 200 may be stored in the storing unit 210. The storing unit 210 may include a program region 211 and a data region 212.

An OS that boots the program for controlling the overall operation of the medical device 200 may be stored in the program region 211. The program region 211 may include a program relating to an operation of the controller 230.

The patient information input from the user through the input unit 250 or the patient information received from the terminal device 100 may be stored in the data region 212 in which data generated when the medical device 200 is used, is stored. The patient information may include the patient's name, the patient's resident registration number, the patient's ID, the patient's current location, the patient's part to be imaged, and the user's management number, and other various information relating to the patient. The worklist may be stored in the data region 212 and may include one or more registered patient information.

In this case, the storing unit 210 may be implemented with at least one of a nonvolatile memory device, such as a cache, a ROM, PROM, an EPROM, an EEPROM, and a flash memory, or a volatile memory device, such as a RAM, or a storage medium, such as a HDD or CD-ROM. However, the exemplary embodiments are not limited thereto.

The communication unit 220 connects the medical device 200 and the terminal device 100 or the server 300 using the wired/wireless network. In detail, when the communication unit 220 receives inspection request signals including the pieces of patient information from the terminal device 100 and the pieces of patient information are registered in the medical device 200, deletion request signals of the patient information are transmitted to the terminal device 100. When the pieces of patient information are first registered in the other medical device 200, the communication unit 220 may also receive the deletion request signals so as to prevent the patient information from being redundantly registered in the remaining medical device 200. A procedure for transmitting the inspection request signals and the deletion request signals will be described later with reference to FIGS. 13 through 15.

The communication unit 220 may include at least one of a wired communication module 221 through which the communication unit 220 is connected to a wired network, such as a LAN, a WAN or a VAN, and a wireless communication module 222 through which the communication unit 220 is connected to all kinds of wireless networks, such as a mobile radio communication network or a satellite communication network.

The controller 230 configured to control the overall operation of the terminal device 100 may perform several operations according to instructions to execute the stored program. The controller 230 may include a processor 231, a ROM 233 in which a control program for controlling the terminal device 100 is stored, and a RAM 232 in which signals or data input from an outside of the terminal device 100 are stored or which is used as a storage region corresponding to various tasks performed by the terminal device 100. The processor 231 may be implemented in the form of a SoC including a core and a GPU. The processor 231 may include a single core, a dual core, a triple core, a quad core, and a core of a multiple thereof.

The controller 230 may include a graphic processing board including the processor 231, the RAM 232 or the ROM 233 disposed on a separate circuit board electrically connected to the controller 230. The processor 231, the ROM 233, and the RAM 232 may be connected to one another via an internal bus.

The controller 230 may be used as the term that refers to as a component including the processor 231, the RAM 232, and the ROM 233. The controller 230 may also be used as the term that refers to as a component including the processor 231, the ROM 233, the RAM 232, and a graphic processing board (not shown).

In FIG. 8, the controller 230 includes the ROM 233 in which the control program for controlling the terminal device 100 is stored, and the RAM 232 in which signals or data input from the outside of the terminal device 100 are stored and which is used as a storage region corresponding to various tasks performed by the terminal device 100. However, the storing unit 210 may include a RAM and a ROM. The storing unit 210 may be disposed in the terminal device 100 or may be implemented to be inserted into the terminal device 100 as a portable device.

When the controller 230 according to an exemplary embodiment receives the inspection request signals from the terminal device 100, the controller 230 may display, register or delete the patient information included in the inspection request signals according to instructions input from the user, and the registered patient information may be stored in the worklist of the data region 212. The controller 230 according to another exemplary embodiment may delete the displayed or registered patient information according to the instructions input from the user or deletion request signals received from the terminal device 100.

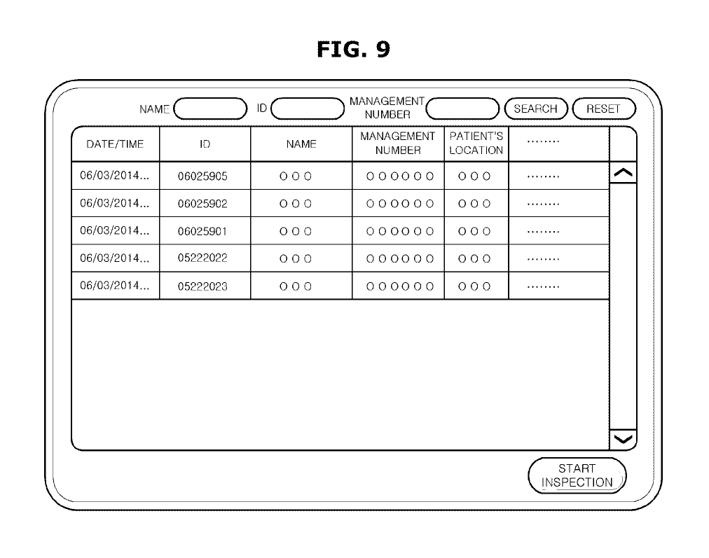

The display unit 240 displays the patient information received from the terminal device 100 and the worklist audiovisually. FIGS. 9 through 12 are views of the patient information displayed by the display unit and the worklist.

Referring to FIG. 9, the display unit 240 displays the worklist stored in the storing unit 210 visually. Each of items of the worklist includes pieces of patient information relating to the registered patient, such as the patient's ID, the patient's name, the user's management number, and the patient's current location.

The display unit 240 may be implemented using a PDP, an LED or an LCD device. The display unit 240 may use a 3D display that may represent 3D images. The display unit 240 may include a touch screen device. When the display unit 240 includes the touch screen device, the display unit 240 may perform a function of the input unit 250. The touch screen device may be implemented using a decompression touch screen panel or a capacitive touch screen panel. The touch screen device may also be implemented using a touch screen panel using ultrasonic waves or infrared rays. The display unit 240 may include a speaker that displays the pieces of patient information visually and outputs the pieces of patient information acoustically.

As illustrated in FIG. 9, the display unit 240 may display a separate search item, for example, an item using a name, an ID, or a management number, and may provide a searching tool for searching for the patient information displayed on the worklist to the user.

In addition, as illustrated in FIG. 9, the display unit 240 may display an item “start inspection” so that, when the user selects the pieces of patient information and the item “start inspection” using the input unit 250, inspection on the patient may be started. The patient information of the patient whose inspection is performed when the item “start inspection” is selected, may be deleted from the worklist if inspection is completed.

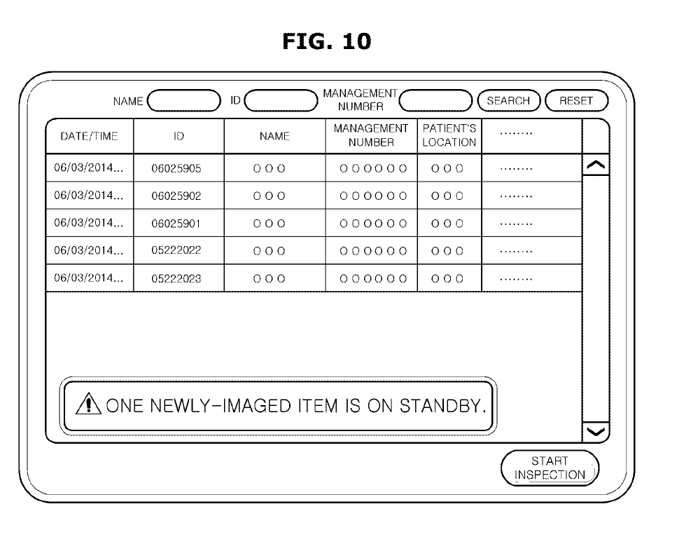

Referring to FIG. 10, the display unit 240 may display a message informing that inspection request signals are received, in a pop-up form when the medical device 200 receives the inspection request signals from the terminal device 100. The pop-up message may be displayed on a left bottom end of the display unit 240, as illustrated in FIG. 10, or may also be displayed in other various forms.

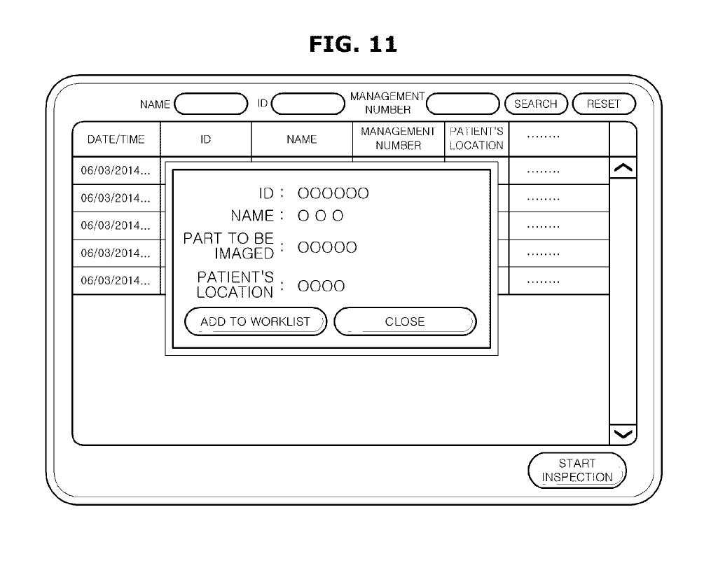

When the user selects the pop-up message using the input unit 250, referring to FIG. 11, the display unit 240 may schematically display the pieces of patient information including the received inspection request signals. The schematically-displayed pieces of patient information that are minimum information for determining whether the pieces of patient information can be added to the worklist, may include the patient's ID, the patient's name, the patient's part to be imaged, and the patient's location.

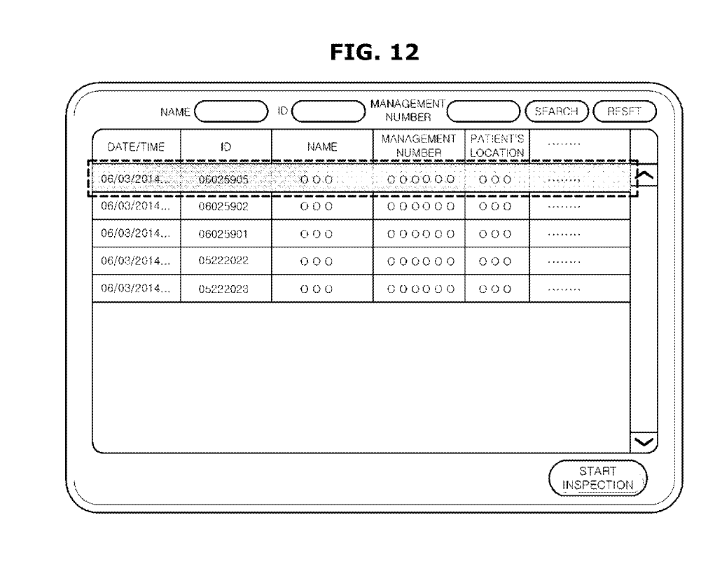

The display unit 240 may further display an item “add to the worklist” through which the user selects to register or add the received patient information to the worklist and an item “close”. When the user selects the item “add to the worklist” using the input unit 250, as illustrated in FIG. 12, the patient information included in the inspection request signals are registered in the worklist, and the communication unit 220 transmits deletion request signals of the registered patient information to the terminal device 100. Further, when the user selects the item “close” using the input unit 250, the patient information included in the inspection request signals are not registered in the worklist but are deleted.

The input unit 250 may allow the user to input various control instructions to the terminal device 100 and may include a plurality of screens through which control instructions can be input while the user sees the display unit 240 that may display pieces of patient information and the worklist. The user may input characters, numbers or symbols for inputting the pieces of patient information using the input unit 250, may select the pop-up message received from the terminal device 100, may select whether to register or delete the patient information, or may input other setting information including information for changing settings of the terminal device 100.

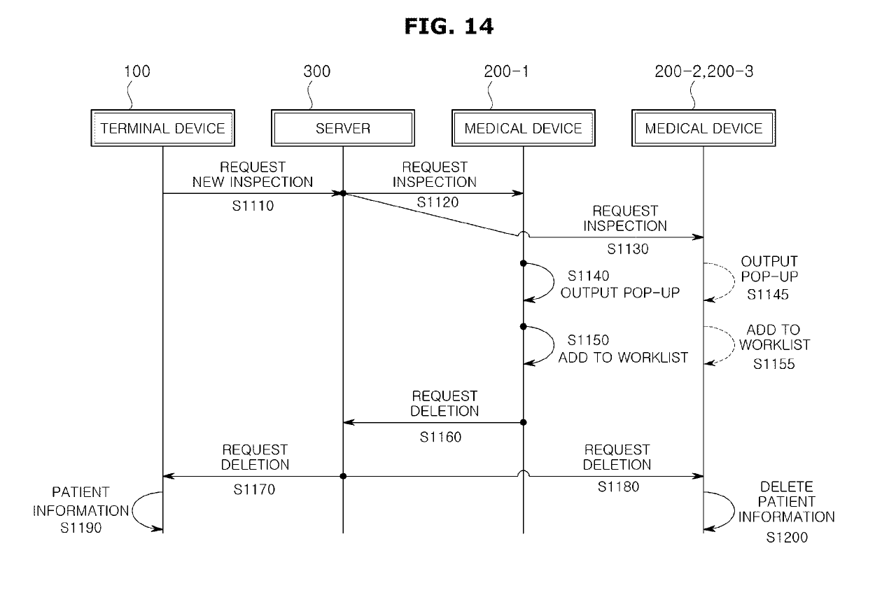

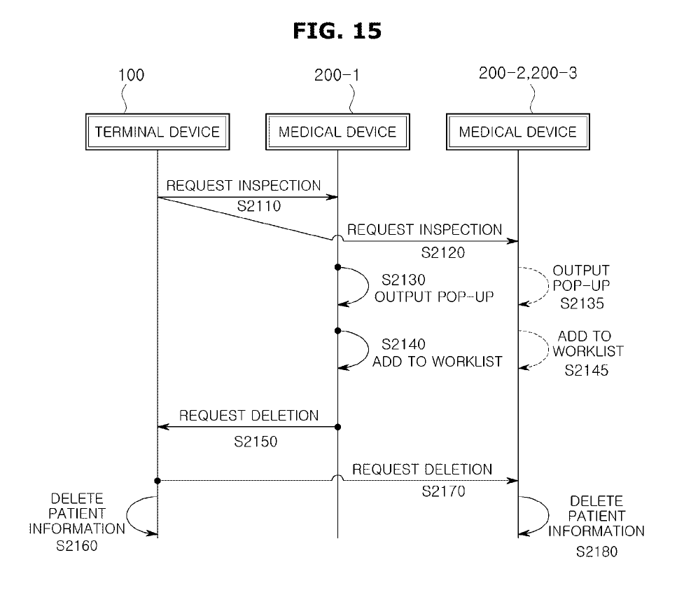

A medical information system according to another exemplary embodiment may further include a server 300. The server 300 controls signal transmission between the terminal device 100 and the plurality of medical devices 200-1, 200-2, and 200-3. FIGS. 13A through 13C are views for describing a signal transmitting operation of a medical information system in accordance with another exemplary embodiment, and FIGS. 14 and 15 are flowcharts illustrating a method of controlling a medical information system, in accordance with an exemplary embodiment. Hereinafter, a signal transmission procedure of the medical information system will be described with reference to FIGS. 13A through 14.

Referring to FIG. 13A, when the terminal device 100 transmits the inspection request signals including the patient information to the server 300 (operation S1110), the server 300 transmits the received inspection request signals to the plurality of medical devices 200-1, 200-2, and 200-3 (operation S1120, operation S1130).

Subsequently, referring to FIG. 13B, when one medical device 200-1 among the plurality of medical devices 200-1, 200-2, and 200-3 that receive the inspection request signals outputs the pop-up message to the user (operation S1140) and the pieces of patient information are registered in or added to the worklist (operation S1150), in order to prevent the patient information from being redundantly registered in the remaining medical devices 200-2 and 200-3, the deletion request signals of pieces of information regarding the patient whose inspection is requested, are transmitted to the server 300 (operation S1160). The deletion request signals include signals indicating that the pieces of patient information are registered or added in or to one medical device 200-1.

Subsequently, referring to FIG. 13C, the server 300 that receives the deletion request signals transmits the deletion request signals of the information regarding the patient whose inspection is requested, to the other medical devices 200-2 and 200-3 so as to prevent the patent information from being redundantly registered in the other medical devices 200-2 and 200-3 (operation S1180). The server 300 may transmit the deletion request signals to the terminal device 100 so that the patient information stored in the terminal device 100 may be deleted (operation S1170).

The terminal device 100 that receives the deletion request signals deletes the information which is input from the user and inspection of which is requested, (operation S1190), and the other medical devices 200-2 and 200-3 that receive the deletion request signals also delete the received patient information (operation S1200) so that the patient information may be prevented from being redundantly registered in the plurality of medical devices 200-1, 200-2, and 200-3.

The pop-up message may be output to the other medical devices 200-2 and 200-3 (operation S1145), and the patient information included in the inspection request signals may be registered or added in or to the other medical devices 200-2 and 200-3 (operation S1155). In this case, the server 300 may acknowledge the deletion request signals only from the medical device 200-1 that first transmits the deletion request signals and may ignore the deletion request signals that reach lately from the other medical devices 200-2 and 200-3.

The medical information system may transmit and receive the inspection request signals and the deletion request signals to and from the server 300, as illustrated in FIGS. 13A through 14, and may transmit and receive the inspection request signals and the deletion request signals to and from the terminal device 100 and the medical device 200, as illustrated in FIG. 15. Hereinafter, a signal transmitting procedure of the medical information system will be described with reference to FIG. 15.

First, the terminal device 100 transmits the inspection request signals including the patient information to the plurality of medical devices 200-1, 200-2, and 200-3 (operation S2110, operation S2120).

Subsequently, when one medical device 200-1 among the plurality of medical devices 200-1, 200-2, and 200-3 that receive the inspection request signals outputs the pop-up message to the user (operation S2130) and the patient information are registered or added in or to the worklist (operation S2140), in order to prevent the pieces of patient information from being redundantly registered in the other medical devices 200-2 and 200-3, the deletion request signals of the information regarding the patient whose inspection is requested, are transmitted to the terminal device 100 (operation S2150). The deletion request signals include signals indicating that the pieces of patient information are registered in or added to one medical device 200-1.

Subsequently, the terminal device 100 that receives the deletion request signals transmits the deletion request signals of the information regarding the patient whose inspection is requested, to the other medical devices 200-2 and 200-3 so as to prevent the pieces of patient information from being redundantly registered in the other medical devices 200-2 and 200-3 (operation S2170). When the terminal device 100 receives the deletion request signals (operation S2150), the information regarding the patient which is input from the user and inspection of which is requested, may be deleted (operation S2160), and when the other medical devices 200-2 and 200-3 receive the deletion request signals (operation S2170), the received pieces of patient information are deleted (operation S2180) so that the pieces of patient information may be prevented from being redundantly registered in the plurality of medical devices 200-1, 200-2, and 200-3.

The pop-up message may be output to the other medical devices 200-2 and 200-3 (operation S2135), and the pieces of patient information included in the inspection request signals may be registered in or added to the other medical devices 200-2 and 200-3 (operation S2145). In this case, the terminal device 100 may acknowledge the deletion request signals only from the medical device 200-1 that first transmits the deletion request signals and may ignore the deletion request signals that reach lately from the other medical devices 200-2 and 200-3.

In the above-described exemplary embodiment, a part of components that constitute the terminal device 100 and the medical device 200 may be implemented with a kind of ‘module’. Here, the ‘module’ refers to software or a hardware component, such as a field programmable gate array (FPGA) or an application specific integrated circuit (ASIC), and performs functions. However, the meaning of the module is not limited to software or hardware. The module may be configured to be placed in an addressable storage medium and to execute one or more processors.

Thus, for example, the module includes components, such as software components, object-oriented software components, class components, and task components, processes, functions, properties, procedures, subroutines, segments of a program code, drivers, firmware, micro-codes, a circuit, data, a database, data structures, tables, arrays, and variables. Functions provided by components and modules may be combined with a smaller number of components and modules or may be further separated into additional components and modules. Furthermore, the above components and modules may execute one or more central processing units (CPUs) within a device.

The above-described method of controlling the terminal device 100, the medical device 200, and the server 300 can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

The above description is just for the purpose of illustrating exemplary embodiments, and it will be understood that one of ordinary skill in the art can easily modify the exemplary embodiments in a different specific form without changing the technical spirit or essential features of the inventive concept. Thus, it should be understood that the above-described exemplary embodiments are just for illustration but are not limitative. For example, each component described in a combined form may be embodied in a distributed manner, and similarly, components described in the distributed manner may be embodied in the combined form.

As described above, according to the disclosed exemplary embodiments, a user can input patient information using a terminal device from a distance so that conveniences can be increased and the input patient information can be registered in one medical device without redundancy.

In addition, according to an exemplary embodiment, the medical device can receive the patient information via a network, and the patient information may not be redundantly registered in the medical device so that a procedure for registering and deleting the patient information can be simplified.

Although a few exemplary embodiments have been shown and described, it would be appreciated by those skilled in the art that changes may be made in these exemplary embodiments without departing from the principles and spirit of the inventive concept, the scope of which is defined in the claims and their equivalents.

What is claimed is:

1. A terminal device comprising:
an input configured to receive pieces of patient information from a user;
a transceiver configured to transmit an inspection request including the pieces of patient information to a plurality of medical devices; and
a controller configured to, in response to the pieces of patient information being registered in one of the plurality of medical devices, control the transceiver to transmit a deletion request of the patient information to remaining devices of the plurality of medical devices.

2. The terminal device of claim 1, further comprising a display configured to display the patient information.

3. The terminal device of claim 1, wherein the controller is configured to delete the pieces of patient information received from the user in response to the pieces of patient information being registered in one of the plurality of medical devices.

4. The terminal device of claim 1, wherein, in response to the transceiver receiving a deletion request, the transceiver transmits the deletion request to the remaining devices of the plurality of medical devices.

5. The terminal device of claim 1, wherein each of the pieces of patient information comprises a user's ID, a part to be imaged, and a user's location.

6. A medical device comprising:
a transceiver configured to receive an inspection request including pieces of patient information and a deletion request of the pieces of patient information;
a display configured to display the patient information based on the inspection request; and
a controller configured to delete the pieces of patient information in response to the transceiver receiving the deletion request.

7. The medical device of claim 6, wherein the display is configured to display a worklist in which the pieces of patient information registered in the medical device are listed.

8. The medical device of claim 6, further comprising an input configured to receive a user selection about whether to register the received patient information.

9. The medical device of claim 8, wherein the display is configured to display a worklist in which the pieces of patient information registered in the medical device are listed, and
the controller is configured to add the received pieces of patient information to the worklist in response to the user selecting to register the received patent information by using the input.

10. The medical device of claim 7, wherein, in response to the user selecting not to register the received patient information by using the input, the controller is configured to delete the pieces of patient information based.

11. The medical device of claim 6, further comprising a storage configured to store the registered pieces of patient information.

12. The medical device of claim 6, wherein the transceiver is configured to receive the inspection request and the deletion request from at least one of a mobile terminal device and a server.

13. The medical device of claim 6, wherein each of the pieces of patient information comprises a user's ID, a part to be imaged, and a user's location.

14. The medical device of claim 6, wherein the display is further configured to display a pop-up message informing that the inspection request is received.

15. The medical device of claim 14, further comprising an input configured to receive a selection of a pop-up message from a user,
wherein, in response to receiving the selection of the pop-up message from the user, the display is configured to display the patient information based on the inspection request.

16. A medical information system comprising:
a terminal device configured to transmit an inspection request including pieces of patient information to a medical device; and
a plurality of medical devices configured to determine whether to register the pieces of patient information,
wherein, in response to the pieces of patient information being registered in one of the plurality of medical devices, the terminal device transmits a deletion request to request deletion of the patient information to remaining medical devices of the plurality of medical devices.

17. The medical information system of claim 16, wherein, in response to a user selecting to register the pieces of patient information in the one of the plurality of medical devices, the terminal device transmits the deletion request to the other medical devices.

18. The medical information system of claim 16, wherein, in response to the pieces of patient information being registered in the one of the plurality of medical devices, the one of the plurality of medical devices transmits the deletion request to the terminal device.

19. The medical information system of claim 16, wherein the one of the plurality of medical devices displays a worklist in which the registered pieces of patient information are listed.

20. The medical information system of claim 19, wherein, in response to the pieces of patient information being registered in the one of the plurality of medical devices, the one of the plurality of medical devices adds the pieces of patient information to the worklist.

21. A terminal device comprising:
a controller configured to receive patient information;
a transceiver configured to transmit an inspection request including the patient information to a plurality of medical devices,
wherein, in response to the patient information being registered in one of the plurality of medical devices, the controller is configured to delete the received patient information.

22. The terminal device of claim 21, wherein, in response to the patient information being registered in one of the plurality of medical devices, the controller is further configured to control the transceiver to transmit a deletion request of the patient information to remaining devices of the plurality of medical devices.

23. The terminal device of claim 21, wherein, in response to the transceiver receiving a deletion request from one of the plurality of medical devices, the controller is further configured to control the transceiver to transmit the deletion request to remaining devices of the plurality of medical devices.
